(19) United States
(12) Patent Application Publication
(10) Pub. No.: US 2008/0288386 A1
(43) Pub. Date: Nov. 20, 2008

(54) Method of Systematic Trend-Following

(75) Inventor: Gavin Robert Ferris, County Down (IE)

Correspondence Address: SYNNESTVEDT LECHNER & WOODBRIDGE LLP, P O BOX 592, 112 NASSAU STREET, PRINCETON, NJ, 08542-0592, US

(73) Assignee: ASPECT CAPITAL LIMITED, London (UK)

(21) Appl. No.: 12/090,918

(22) PCT Filed: Oct. 20, 2006
(86) PCT No.: PCT/GB06/03903

§ 371 Date: Apr. 21, 2008

(30) Foreign Application Priority Data
Oct. 21, 2005 (GB) 0521511.6

(51) Int. Cl. G06Q 40/00

(52) U.S. Cl. 705/35

(57) ABSTRACT

This invention relates to alternative, synthesisable trend-following strategy, based on a rolling, delta-spliced lookback straddle. This operates like a conventional lookback straddle, except that the time to expiry, rather than monotonically running down to zero, is reset where possible to that of a ‘younger’ straddle, provided that the delta of the two straddles does not differ by more than a specified amount. It is more computationally efficient than prior art approaches; further, it does not lead to positions being prematurely liquidated.

### BACKGROUND OF THE INVENTION

1. Field of the Invention

This invention relates to a method of systematic trend-following of an underlying financial instrument. The method can be used in various contexts, such as a trading system, a performance benchmarking system, an investable index, and a performance attribution analysis system. An advantage of one implementation of the invention is that is has significantly improved computational efficiency.

2. Description of the Prior Art

Trend-following, particularly systematic trend following, is a highly important part of the current hedge fund universe. As of the end of Q2 2005, this overall hedge fund industry had grown to over $1 bn in assets under management (AUM), according to the Barclay Trading Group, of which managed futures was $127.1 bn (around 12.2%); of this, a large proportion (probably the majority) executes some form of ‘trend following’ strategy. Graham Capital's document ‘Trend Following: Performance, Risk and Correlation Statistics’, available from that company on request, provides a useful analysis of the prevalence of trend-following, and also provides a basic primer.

Trend-following (TF) is a largely self-describing trading strategy. It's goals are to catch all major price moves in each traded market, essentially by letting winning trades run, and cutting losing trades before they get out of hand. Researchers Fung and Hsieh published a paper in 2001 showing that the performance of funds using TF is not well explained using traditional linear-factor models using benchmark indices (Fung, William and David A. Hsieh (2001) “The Risk in Hedge Fund Strategies: Theory and Evidence from Trend Followers.” Review of Finatcial Studies, Vol. 14, No. 2 (Summer), pp. 313-41). Rather, TF returns are option-like in nature. The authors suggest using lookback straddles (explained below) on a recurring fixed stride pattern (which they term the primitive trend following strategy' or PTFS), as a basis for benchmarking the performance of funds using TF.

Now, TF is a useful portfolio addition, given its low correlation to traditional asset classes and hence diversification benefits, and therefore responsible asset managers may well wish to add a TF component to their allocations. However, most TF providers, being hedge funds, charge hefty fees; with the median being around 20% performance fee (charged on profits) and 1% management fee (charged on AUM) per annum (See, for example, Ineichen, Alexander (2003) Absolute Returns: The Risks and Opportunities of Hedge Fund Investing, John Wiley and Sons Inc., NJ, p. 48 (quoting Van Money Manager Research on characteristics of a typical hedge fund). Therefore, it would be highly beneficial for asset managers to have a computer implemented methodology (trading strategy) that would enable them to replicate ‘passive’ trend-following strategies at low cost and with computational efficiency.

One might suppose that, following Fung and Hsieh that either direct lookback straddle purchases, or more practicably replication of the same using delta synthesis (discussed below), would be a useful technique. However, as we will demonstrate, pace these authors, lookback straddles on a fixed stride pattern have serious drawbacks and do not accurately teptesent how trend-following funds actually trade.

Structure of this Document

We begin by briefly describing the hedge fund universe, motivating the requirement for a viable, implementable, computationally efficient, deterministic algorithm to replicate trend-following (TF) behaviour over any given market, both to allow the creation of inexpensive portfolio additions and to provide a performance benchmark/attribution tool for use with funds implementing TF strategies. We will concentrate here on the application to underlying markets that are linear, such as stocks, foreign exchange rate futures, commodity futures etc. The extension to underlying non-linear instruments, such as options, is straightforward and calls only for the use of the appropriate option model in calculating the delta. As part of this discussion, a number of important characteristics of trend-following ate described.

Next, we consider the existing state of the art—specifically, ‘entry and exit rule’ (EER) based approaches such as the Turtle Trading rules, and replication approaches using lookback straddles (RLS) of fixed stride.

Then, we show why both these existing approaches fail to match the true characteristics of an idealised TF, suitable for use either as a proxy investment or as a benchmark index. Having established the weaknesses of the existing public-domain models, we introduce our own OptRISK strategy, which synthetically creates a rolling, delta-spliced lookback option. This is a non-price-ptedictive algorithm that may straightforwardly be implemented by a third party. It has firm foundations in finance theory, and does not contain arbitraty methodology or rules.

Finally, we show why this model matches real-world TF characteristics well and why, in particular, it outclasses both EER and RLS approaches when trading actual markets (where costs of trading exist).

A Mathematica notebook at Appendix 1 contains explicit quantitative models of both the PTFS and OptRISK, and demonstrates the latter's performance benefit. This model provides an unambiguous particular embodiment of the OptRISK invention.

Trend Following Within the Hedge Fund Universe

Hedge funds are lightly regulated trading vehicles that specialise in strategies differentiated (in general) from that of the typical ‘long only’ equity/bond/cash portfolio manager. The popularity of hedge funds has been increasing rapidly—growing from an estimated $100 m AUM in 1995 to over $1 bn 10 years later.

Now, hedge funds cover a wide variety of strategies, such as long/short equity, event driven, global macro, fixed income arbitrage, emerging markets, equity market neutral, convertible arbitrage, dedicated short bias and managed futures. Descriptions of these strategy classes may be found in Ineichen (2003), op. cit. Of these, the most relevant to our discussion here is managed futures, of which according to Rulle (op. cit.) “a significant percentage [is] devoted to trend following”. The proportion of the total hedge fund AUM allocated to managed futures varies over time, but has generally averaged around the 10% range, making this (and by implication, trend following), a highly important economic activity.

Furthermore, the characteristics of TF mean that it is likely to enjoy greater exposure in the future, making its economic relevance even more pointed. As Rulle (op. cit., p. 47) points out:
“Trend following's [. . . ] unique quality, which is related to its “long option” return profile, is its correlation charactetistics. It is one of the only strategies which is negatively correlated to stocks during negative equity markets and which also exhibits an increase in correlation when equity markets are very positive. However, its largest benefit to a diversified portfolio of hedge funds arises from its high negative correlation when the equity market declines. [. . . ] Asset allocatots should explicitly factor in [autocorrelation, skew, kuttosis and upside/downside volatility] when determining their optimal portfolios. If they do, it will likely tesult in a higher allocation to trend following than previously considered.”

If we accept that TF is increasingly important for asset allocators, then there are three issues that become relevant, namely:
Hedge funds typically charge relatively high fees (e.g., a 20% performance fee and a 1% management fee), so ideally it would be possible to set up a ‘passive’ TF strategy using transparent, pre-determined algorithms. Such a strategy might not outperform the best TF funds, but if its costs were low and liquidity high, it might still be a very useful portfolio addition for allocators.
Given (per Fung and Hsieh, op. cit.), that “Hedge fulnd strategies typically generate option-like returns. Linear-factot models using benchmark asset indices have difficulty explaining them”, the creation of ‘benchmatk’ standardised TF strategies for certain markets (e.g., Nymex Crude Oil Futures) or groups of markets (e.g., a weighted basket of energy futures, such as Crude Oil, Heating Oil, Unleaded Gasoline and Natural Gas), is important to be able to attribute ‘alpha’ to fund managers.
Similarly, the use of such non-lineat models is critical to build ex-post regression models for funds, allowing allocatots to ‘data mine’ the main drivers of performance (and risk factors) to which a TF fund is exposed.

Therefore, as may be appreciated, the provision of a transparent, non-arbitrary, computationally efficient trend-following algorithm is of great economic relevance. It is just such an algorithm that is laid out in this paper.

A Brief Discussion of (Systematic) Trend Following

Most asset markets ‘trend’—that is, exhibit a drift component (also referred to as serial autocottelation of returns) in addition to their non-ditectional volatility—at least some of the time. It is this which trend-following (TF) strategies attempt to capture. For the purposes of this discussion, we will be most interested in diversied, systematic, non-anticipatory trend-following; by which we mean to imply the following characteristics:
Diversified, in that the strategy simultaneously trades multiple markets with low correlation to each other. Since no markets trend continuously, effective TF strategies must be applied with appropriate risk constraints across a basket of markets simultaneously.
Systematic, in that the strategy is codified into a set of non-discretionary rules. These rules may then be executed either by humans or by computerized trading systems.
Non-anticipatory, in that the strategy does not attempt ‘market timing’—that is, calling a ‘top’ or ‘bottom’ of the market and hence determining the onset of a new trend a priori.

As Rulle (op. cit.) points out:
“Systematic trend following is a “macro” strategy which trades futures and forward contracts in the currency, fixed income, equity, and commodity markets. A trend following program may trade as many as 80 different markets globally on a 24 hour basis. Trend followers try to capture long term trends, typically between 1 and 6 months in duration when they occur.”

The Sources of Trends

Given the statistical performance of trend followers (backed up by the votes of the marketplace investing in TF funds), it may be taken as given that markets do, in fact, trend. Pet Rulle (op. cit.):

“[Trend following] uses statistical financial modelling with known quantitative techniques to capture long term trends and has a twenty year track record demonstrating its viability. [. . . ] The documented historical record of trend following indicates this tesults in a positive expected return significantly higher than zero.”

The ultimate sources of trending behaviour are not hard to discern. There are basically three:
Business cycles—the natural flows of supply and demand—create periodic, systemic movements in price. Commodity cycles are a case in point here. As the famous trader Jim Rogers points out (Rogers, Jim (2004) Hot Commodities: How Anyone Can Inivest Profitable in the World's Best Market, Random House), it takes a long time from the first ‘price signals’ indicating commodity scarcity, for mines, production facilities etc. to be planned, financed, approved and brought on stream. This leads to statistically robust ‘long cycles’ in many such markets.
Money supply growth. The money supply is expanding faster than productivity growth worldwide, and has been for years. This ‘excess liquidity’ has to flow somewhere, and it finds outlets in equity markets (boom to 2000), the housing markets (boom post 2000), and now (2003 onwards) it has been adding fuel to the commodity markets. The FIG. 1 chart shows how broad money supply has grown in the US since 1957. With the deregulation of the credit markets, it is increasingly banks and non-governmental agencies that are creating additional demand directly, through the creation of e.g. extensive mortgage credit. Where debts are backed by the assets that are financed by the debts, and particularly when the market is illiquid (as is the case with housing), feedback loops can easily be created that lead to persistent price trends.
Behavioural and systematic effects. As many authors have pointed out, humans often succumb to ‘herding‘; this often reinforces the progress of an ongoing trend as those ‘left out’ clamour to get on board—even where the underlying entity is objectively overvalued, as was the case with the ‘irrational exuberance’ of the Internet bubble.

Furthermore, with the increase in algotithmic trading and dynamic hedging, computers issuing trading orders can also rush for the exits (or the entries) at the same time. The stock market crash of 1987 was an example of such a move created largely by ‘portfolio insurance’—as the price of the index fell, more and more managers were forced to short the index more and mote heavily to ‘cover’ their positions—which of course only increased the market's precipitous decline.

The Optionality of Trend-Following Strategy Returns

Trend followers, by virtue of ‘letting winners run’ and ‘cutting losers short’ tend to have a long option payout function. Per Rulle (op. cit.):
“Trend following tends to create a long option, high upside volatility, positive skew teturn profile in global interest rate, currency, commodity, and equity markets.”

Because trend followers are wiing to go long or short (in general), it is natural to model their trading strategy as a form of straddle or strangle option combination. We define this as follows:
A call option is a contract conferring on the purchaser the tight, but not the obligation, to buy a certain quantity of a specified underlying instrument at (and/or until) some point in the future, at a fixed price known as the strike, in exchange for an option premium paid to the option seller.
A put option is similar, except that it confers the right to sell at the strike price, rather than buy.
A straddle is defined as a long call and long put option both purchased with the same strike and maturity (tine to expiry), often ‘at the money’ (ATM—that is, where the strikes are at, or approximately at, the curtent price of the underlying asset in the spot market).
A strangle is similat to a straddle, except that the call is purchased at a higher strike than the put. Both option ‘legs’ are often OTM (out of the money) when the straddle is created.
A ‘long’ position is one that is purchased, with the aim (in general) of later selling at a higher price. A ‘short’ position, by contrast, is one that is borrowed and then sold, with the aim of later buying back (or ‘coveting’) at a lower price. For certain derivative contracts, the counterpatty with the obligation to deliver is said to be ‘short’ and the other ‘long’ the contract—with options contracts, generally the premium receiver is said to be ‘short’ the contract (as s/he has incurred an obligation for which the ptemnium is consideration) and the premiun payer is said to be ‘long’ (as s/he holds the concomitant rights).

The optionality of TF strategy returns is part of their attractiveness for portfolio managers, of course, since they can act as excellent diversifiers to ‘conventional’ stock and bond portfolios. However, this non-lineatity also poses problems—it renders conventional benchmarks (which look at correlation to underlying linear indices of stocks, bonds etc.) useless—and also means that a simple ‘buy and hold’ or ‘rebalanced buy and hold’ strategy cannot be used to create an investable equivalent index.

It is clear, therefore, that to be able to advance these objectives, we must build an appropriate, and simple, model of a trend following strategy. We will now look at the two most prominent such models that are in the public domain: the ‘Turtle Trading’ rules, and the Fung and Hsieh lookback straddle model.

The Turtle Trading Rules

The ‘Turtles’ were a group of individuals trained by veteran traders Richard Dennis and Bill Eckhardt, in order to establish whether a purely systematic trading model could be taught successfully to novices (the answer was a resounding yes—as Curtis Faith remarks (op. cit.): “The Turtles became the most famous experiment in trading history because over the next four years [after completing the training], we earned an average annual compound rate of return of 80%.”)

The Turtle Rules have been published, and are now in the public domain. The Turtle strategy meets the criteria of a diversified, systematic, non-anticipatory trend following approach. It is also an example of an ‘entry and exit rules’ (or EER) approach. A trader starts off with no positions. When the price action in a given market dictates (i.e., an enty rrile is triggered, s/he enters the trade long or short as indicated). The position is then carried until an appropriate eat rule is triggered, closing the position.

The Turtle tules specify both a long-term and shott-tern system. The basic long-term rules are as follows:
When the price exceeds the high in that instrument over the past 55 days, enter 1 unit long (if not already in the mnarket). This is a long entry rule.
When the price falls below the lowest price in that instrument over the previous 55 days, enter 1 unit short (if not already in the market). This is a short entty rule.
A unit=the number of contracts of a given instrument (e.g., a crude oil future) that would expose the total account to a 1% loss, given a 1 N move in that instrument. The N is the 20-day exponential moving average of the ATR (average true range)—this is a simple volatility position sizing rule. (defining day t's ATR as ATRₜ=Max(Highₜ−Lowₜ, Highₜ-Closetₜ₋₁, Closeₜ₋₁-Lowₜ); then compute N=exponential moving average of ATR over 20 days.)
Positions are closed out if a long position is active and the price falls below the lowest low for the previous 20 days. This is a long exit rule.
Similarly, positions are closed out if a short position is active and the trades above the highest high for the previous 20 days. This is a short exit rule.
For long positions, units are added to open positions at ½ N price increments above the trade entry price. They are removed again if the price falls back through that level. One unit is added for each 1/2 N step, until a maximum of 4 units is exposed. This is a long position scaling rule.
For short positions, units ate added to open positions at ½ N price increments below the trade entry price. They are removed again if the price rises back through that level. One unit is added (short) for each ½ N step, until a maximum of 4 units is exposed. This is a short position scaling rule.
There are also a number of maximum position limits—no more than 4 units in any single instrument, no move than 6 units in any given direction in closely correlated markets, no more than 10 units in any direction in weakly correlated mnarkets, and no mote than 12 units in any direction in total.

The net effect of these rules is a crude kind of replication, or synthesis, of a straddle (or more accurately, strangle) option. This is because the ATR is essentially a measure of daily historical volatility (more conventionally estimated as the standard deviation of the daily log return), and the use of high and low bteakouts to trigger entry are in effect volatility adjusted entry thresholds that act as an additional risk safeguard (essentially, a strangles whose strikes widen with volatility). Then, the scaled entry as the price moves in the desired direction, with equivalent position reduction on retracements, act like ‘delta replication’ of an option, either a long call option on the upward breakout, or a long put option on the downward breakout. The process of delta replication of an option is described in more detail below when we consider the OptRISK strategy. The values and steps do not exactly match those dictated by option theory of course, but the effect is close enough to operate successfully, as the history of the Turtle Traders themselves demonstrates.

The Lookback Straddle Model and its Weaknesses

In their influential paper of 2001, Fung and Hsieh (op. cit.) proposed an explicit model for trend following, in which lookback straddles would be used, with a fixed stride, say 3 months. The modeler would take, for each market (e.g., crude oil) the payout of a lookback straddle over each three month period as the maximum return for a trend follower, against which performance could then meaningfully be benchmarked.

As has been explained, a straddle is a combination of a call and a put struck with the same maturity, strike price and underlying. By contrast, the lookback straddle consists of a lookback call and a lookback put. The lookback call pays out the absolute difference between the lowest ptice teached over the period Sₘᵢₙ (‘looking back‘) and the price at the end of the period S′, and similarly the lookback put pays out the absolute difference between the highest price reached over the period Sₘₐₓ and the price at the end of the period S′. Assuming the price at the start of the period was S, then we have (see FIG. 2):
Payout of standard (perfectly) ATM straddle at end of period=|S′-S|.
Payout of the lookback straddle is Sₘₐₓ-Sₘᵢₙ.

The authors claim that the standard straddle actually represents a reasonable model of a trading methodology they term the ‘primitive maatket timing strategy’ or PMTS, whereas the lookback straddle models that of the ‘primitive trend following strategy’, or PTFS.

As the authors explain, the lookback straddle can be synthetically created with a pair of conventional ATM straddles; the technique is originally from M. Goldman, Sosin, H. and Gatto, M. 1929 “Path Dependent Options: ‘Buy at the Low, Sell at the High,’” Journal of Finance, 34, pp. 1111-27:
“The replication process calls for the purchase of two at-the-money straddles at inception using standard puts and calls. We use one straddle to lock in the high price of the underlying asset by rolling this straddle to a higher strike whenever the price of the underlying asset moves above the current strike. At expiration, this straddle's strike must equal the highest price achieved by the underlying asset since inception. We use the other straddle to lock in the lowest price of the underlying asset by rolling the straddle to a lower strike whenever the price of the underlying asset moves below the cutrent strike. At expiration, this latter straddle's strike must equal the low price achieved by the underlying asset since inception. Thus, the pair of standard straddles must pay the difference between the maximum and minimum price achieved by the underlying asset from inception to expiration, which is exactly the payout of the lookback straddle.”

Although the Fung and Hsieh approach is mainly aimed at created benchmarks for the performance analysis of TF managers, it could potentially be used to create an ‘investable index’ as well, using exchange traded calls and puts on commodities to create the lookback straddles. In their paper, the authors looked at creating five replicating ‘baskets’, for stocks, bonds, interest rates, foreign exchange and commodities. Futures were used to derive the spot price and (three month) duration options used to determine the appropriate straddle prices.

The synthetic ‘PTFS’ thus created was shown by the authors to have reasonable explanatory power when used as a regressor for existing funds' ex post returns—with superior capability to regression against simple linear underlying markets, such as a long equity basket etc.

Advantages and Disadvantages of the PTFS Approach

This ‘replication of lookback straddles’ (RLS) approach has a number of advantages over a entry and exit rule (EER) methodology, for the portfolio managet wishing to create an investable index, benchmark, or performance attribution tool. Specifically:
There are no entry and exit rules based upon somewhat arbitrary prior history highest highs/lowest lows. Instead, options are purchased and rolled as required over the duration of the window.
The crude scaling in and out of the EER approach has been obviated in favour of one that uses scaling based on a risk-neutral measure.
The volatility attribution inherent in the model has been shifted from a backwards-looking approach (using the ATR, a method of determining histotical volatility) to a forwards looking one (the price paid for actual call and put options embeds the market's estitnation of future volatility).

However, the approach also suffers from its own drawbacks and arbitrary factors, which make it less than an ideal choice. The mote important issues are:
The use of a fixed-stride window still makes two implicit choices—the start of the period and the length of the window (‘stride’—in Fung and Hsieh's case 3 months—was chosen to optimize the quality of available option data). While the use of lookback straddles ensures that the maximum price move over the period is captured, the option premiums may vary significantly over this time.
Utilizing a four-option implementation is not realistic for implementation. There are (very) high bid-ask spreads on most options, making for large transaction costs when forced to toll to a new strike.
However, assuming that this problem is countered by using delta replication of the lookback straddles instead, there is still one huge problem with the PTFS. Namely, at the expiry of the straddle, the current position must be closed out and another entered ATM, eating a potentially large shift in exosure with attendant trading costs. This can be most clearly seen in a strongly trending mnarket, where e.g. the prices have been moving strongly higher, and where delta synthesis is used for replication. In this instance, the delta will move from effectively 100 to 0 as the new window is entered. It is true that this delta will then rapidly ramp up to over 100 again;

however, large transaction costs will be incurred in the interim. A true trend follower would not exit in this case as there would be no evidence that the trend had ended—only that a particular time duration had expired. This ptoblem also obtains with the simple straddle (‘PMTS‘) approach as defined by Fung and Hsieh (op. cit.).
The determination of a PTFS as one that captures the maximum move over a period is simplistic. No non-anticipatory trend follower can possibly capture such a move (other than by luck), as on the first tick of (what subsequently proves to be) a major move, there is no statistical evidence that a trend is in progress. Indeed, what would really be happening here is the strategy calling a turning point—which would be indicative, in normal trading parlance, of a market timing strategy However, the PMTS that the authors use restricts the trading choices to going long or short the asset at the start of the time period, intending thereby to gain |S′-S| if correctly implemented. While this terminology does follow Metton's idea of a single trade over the time period (R. C. Merton, 1981, “On Market Timing and Investment Performance I: An Equilibrium Theory of Value for Market Forecasts,” Journal of Business, 54, pp. 363-407), it is then incommensurate with the PTFS which will, by definition, require at least an intra-petiod entry if it is to be implemented directly in the underlying.

By contrast, the OptRISK approach provides a trend following strategy by synthetically creating lookback straddles through (delta) replication in the underlying, and extends the windows of these straddles where possible. We now turn to consider this strategy in mote detail (the reader is also referred to the accompanying Appendix 1 Mathematica notebook).

### SUMMARY OF THE INVENTION

The present invention is a method of systematic, computer-implemented, trend-following of an underlying financial instrument, in which an algoritlim synthetically creates an option by using the delta of the underlying financial instrument, i.e. the partial derivative of the option price with respect to the underlying instrument.

A second aspect of this invention is a method of lowering the computational overhead involved in a computer implemented system that implements trend-following trading of an underlying financial instrument, the method including the step of an algorithm synthetically creating an option by using the delta of the underlying financial instrument, i.e. the partial derivative of the option price with respect to the underlying.

The synthetically created option can be a lookback straddle. If the lookback straddle has a delta that falls within a predefined range, it is substituted with (i.e. spliced to) a younger straddle that has a sufficiently similar delta, to prevent premature expity of a position in the underlying instrument. The predefined range can be approximately + or −1.

The present invention therefore enables an alternative, synthesisable ttend-following strategy, based on a rolling delta-spliced lookback straddle. This operates like a conventional lookback straddle, except that the time to expity, rather than monotonically running down to zero, is reset where possible to that of a ‘younger’ straddle, provided that the delta of the two straddles does not differ by more than a specsifed amount. This process we refer to as ‘delta splicing’. Such as system may be used by asset allocators wishing simply to benchmark the performance of invested funds (or to data-mine the underlying sensitivies of such funds), and also (most likely through option replication) by those managers who wish to create their own, low-cost trend-following models over one or more underlying markets. The trading strategy we describe, named OptRISK, has a number of important advantages when compared with traditional TF models. It is significantly more computationally efficient. It does not depend upon specifying specific entry and exit dates (or criteria) upon which trades are initiated and closed (unlike existing published TF models, such as the ‘Turtle Trading’ rules—See Faith, Curtis, 2003, The Original Turtle Trading Rules. Available from www.originalturtles.org). It allows multiple time windows to be captured. It provides for a progressive management of risk exposure. And, unlike the fixed-stride lookback straddle model, provides an accurate representation of the operation of a generalized TF approach to a given market—most importantly, it captures the fact that a TF fund will be content to stay fully exposed to a given market as long as the underlying trend continues in their direction, and will not arbitrarily exit positions (as the PTFS demands on option expiry boundaries).

Implementation specific details include the following:
a nominal duration of the straddle can be set a priori, or instead set by the most reliable implied volatility option duration for the underlying.
multiple windows (with offsets to each other, and possibly, different nominal lengths) ate weighted by a user-defined multiple and then combined to create a final target position delta.
small random offsets (‘dither’) are applied to the nominal duration to help prevent market predation.
the user may set the ranges of ‘eligible delta’ when splicing may take place, and also the percentage ‘closeness of match’ in the deltas for matching to take place.
the percentage may be different for splicing towards and away from the zero delta point.
the ‘youngest’ possible straddle that matches (assuming the current straddle is eligible) will be selected where there are multiple of similar ‘closeness’.
the ‘time to run’ of a straddle is algotithmnically factored into that straddle's ‘splice utility’ through user-parameterized factors.
the user may set the minimum and maximum time window that is searched, when looking for a delta match.
a user-parameterised hysteresis is employed to prevent splicing occurring at too-frequent an interval.
the use of quantized delta ‘bands’ (e.g., −Infinity to −1, −0.99 to −0.8, −0.79 to −0.6 etc.) is recognized and utilized by the splicer (i.e., quantize and then look for the appropriate splice, not vice versa).
a non-lognormal price process is assumed, and in which the delta of the lookback straddle is computed appropriately perhaps using numerical differencing, rather than using an analytical form).
the algorithm is applied to trading individual equities, commodity futures, indices, and foreign exchange instruments and combinations of such instruments, without limitation.

A third aspect is a method of performance benchmarking for trend-following funds, the method including one or more of the steps or features defined above.

A fourth aspect is a method of creating an investable index at low cost on a single instrument or set of such instruments, the method including one or more of the steps or features defined above.

A fifth aspect is a performance attribution analysis system, the system deploying in use a method that includes one or more of the steps or features defined above.

A sixth aspect is a method of trading, the method including one or more of the steps or features defined above.

### BRIEF DESCRIPTION OF THE DRAWINGS

The present invention will be described with reference to the accompanying drawings, in which:

FIG. 1 is a chart that shows the growth of broad noney supply in the US since 1957:

FIG. 2 illustrates a lookback straddle option;

FIG. 3 illustrates how lookback straddles liquidate positions;

FIG. 4 shows how OptRISK delta-spliced straddles (an implementation of the invention) in effect hold positions at full delta;

FIG. 5 illustrates a set of 100 random price walks;

FIG. 6 illustrates one random price walk;

FIG. 7 illustrates how the delta of a normal rolling, lookback straddle compares with the OptRISK delta-spliced straddles;

FIG. 8 illustrates how normal rolling, lookback straddle compare with the OptRISK delta-spliced straddles on a time to run basis;

FIG. 9 shows how OptRISK delta-spliced straddles outperform normal rolling, lookback straddles.

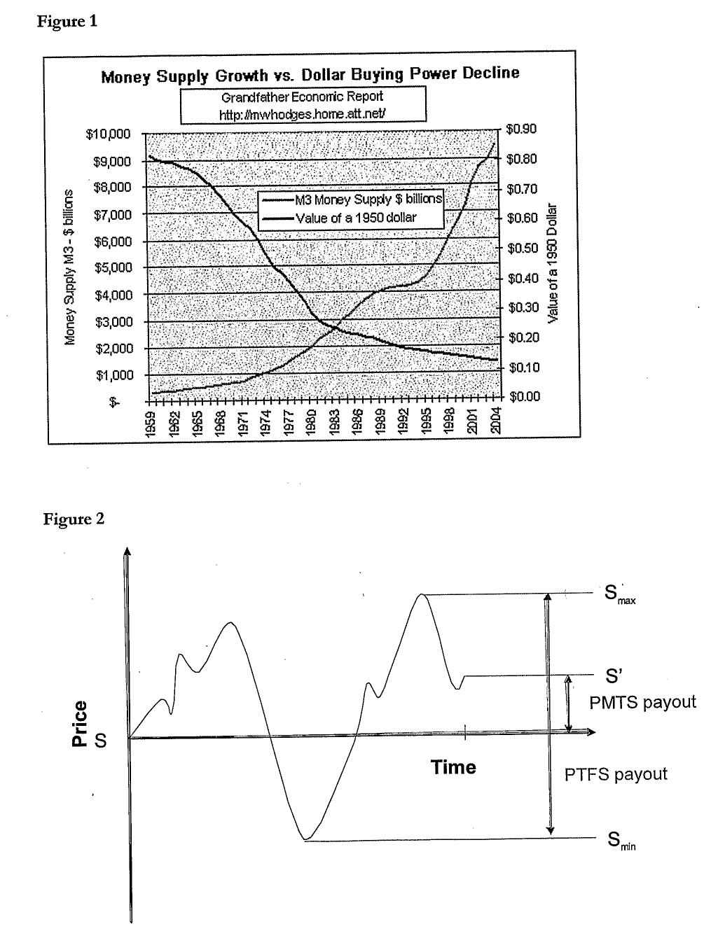

### DETAILED DESCRIPTION

The OptRISK Strategy Explained

Options are examples of contingent claims, and (given certain assumptions) any such derivative may be replicated in the underlying through a combination of a position in the underlying and a tisk-free bond, over a sufficiently short time-step (see e.g. M. W. Baxter and A. J. O. Rennie, 1996, Financial Calculus: An Introduction to Derivative Pricing, Cambridge University Press). This replication in fact provides the basis of no-arbitrage pricing of options, and, while it relies upon certain assumptions (e.g., a continuous market that may follow a known return distribution—for example, log-normal with a drift), is nevertheless very useful.

Where the partial derivative of the option ptice with respect to the underlying is available (the delta), then this value at any point in time may be used to replicate, or synthesize, the option position. The result is an approximation which will increase in accuracy as the size of the time-step between delta calculations is reduced.

Most frequently, this process is actually referred to not as replication but as dynamic hedging. For example, suppose an institution sells a call option for mote than its theoretical price. To ‘lock in’ the profit, it then delta hedges by creating (replicating) a long option position to match its short option exposure. If this is done successfully, then (on average) the result will be a profit equal to the original excess value in the option sold. While it is true that simply allowing the option to run to expiry would also yield this profit on average, the variance of the return is greatly reduced through hedging. This process is well understood, see for example S. Benninga and Z. Wiener, “Dynamic Hedging Strategies”, Mathematica in Education and Research (1998) 7 1, pp. 1-5. Furthermore, and as a more general point, the enforceable (no-atbitrage) price of a derivative is the important thing, not the discounted expected value of its payoff—although the two may converge. Nevertheless, one can equally well replicate an option without a corresponding ‘real’ derivative exposure. In the idealized case of costless trading, continuous markets etc., the average p/1 (profit or loss) of executing the replication of a typical option strategy will be zero in the absence of drift.

Generally, real options have a very high bid-ask spread, whereas the underlying may have a relatively low cost of trading; in such circumstances, delta replication is the preferred route to create the derivative.

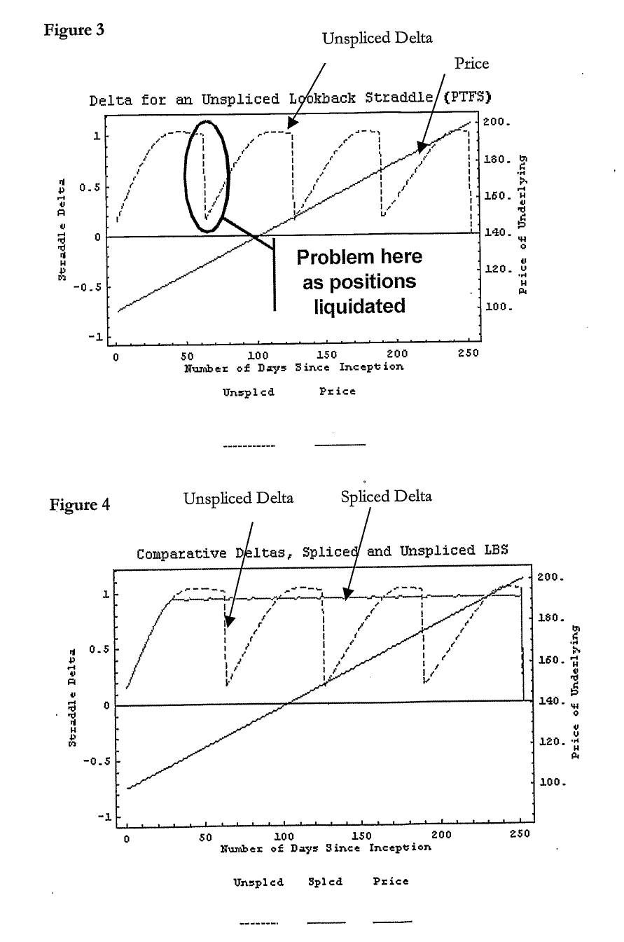

Now, if we consider the didactic case of an underlying whose price tises linearly over the course of a year (252 trading days), but in which there is some cost in trading the underlying, then the PTFS of Fung and Hsieh (op. cit.) has a clear problem—it will force (almost) the whole position to be closed out when the ‘option’ expires, which is expensive, does not accurately reflect how trend followers actually operate, results in lower overall net exposure in the face of a strong trend, and creates a regular ‘footprint’ that others in the marketplace may learn to exploit. FIG. 3 illustrates this (here volatility has been assumed at 20% p.a., with a 5% risk-free rate, and the straddles have 3 month=63 trading day duration).

For OptRISK, we similarly use lookback straddles as out basis, taking the standard definition from the literature (see attached Mathematica notebook). However, we impose the following additional specification:
The nominal duration of the straddle may either be set by fiat, or may be set by using the most reliable measure of implied volatility (e.g., this may turn out to be a three month window, but need not be). Reliability is measured by comparing the actualized versus implied volatility over past history; it is available only where liquid options are trading.
The straddle will be ‘spliced’ when its delta falls into a pre-determined range (generally, this will be deltas near ±1), if there is any other straddle which has the same initial duration but which is, at that point, further away from expity and sufficiently similar delta. This in effect extends the life of the straddle by substituting it with a younger, but delta-similar, synthesized option whenever possible.

The net effect of this delta splicing is that, in the face of major trends, positions are held at full delta and not expired. In situations of intermediate delta, the straddle operates as a regular lookback replication, but in such circumstances, the costs of rolling are mitigated.

FIG. 4 shows how a spliced straddle's delta evolves in die simple situation just considered (tefer to the accompanying Appendix 1 Mathematica notebook for full details of this).

Notice how the spliced straddle stays long as the price tises, and does not artificially reset.

A More Realistic Example

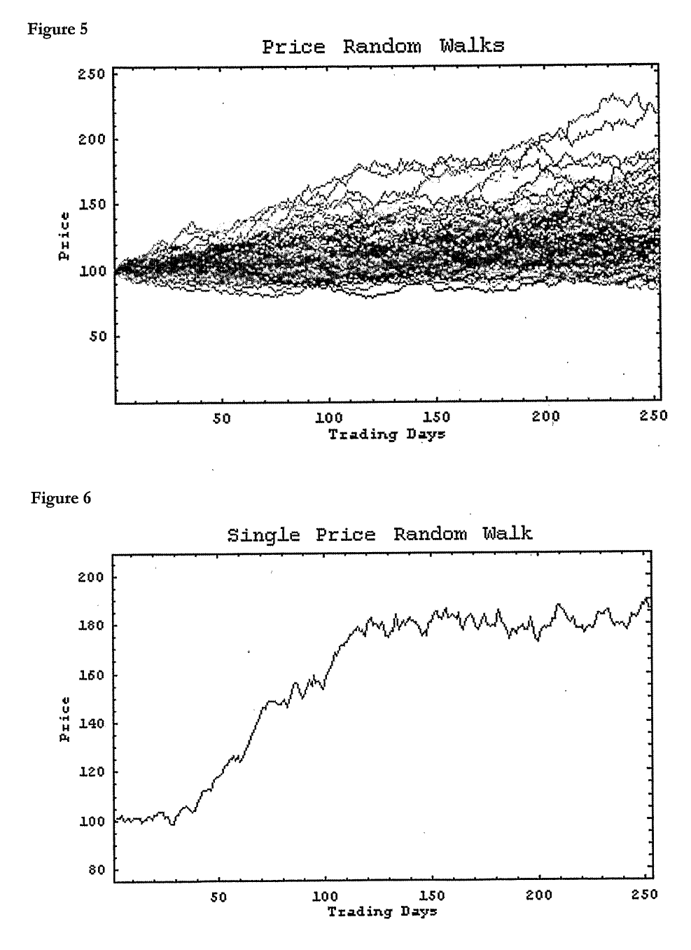

We can now turn to a more realistic example. We create (see FIG. 5) a set of 100 random price walks, assuming a log-normal diffusion process, with drift of 25% p.a. and volatility 20% p.a.

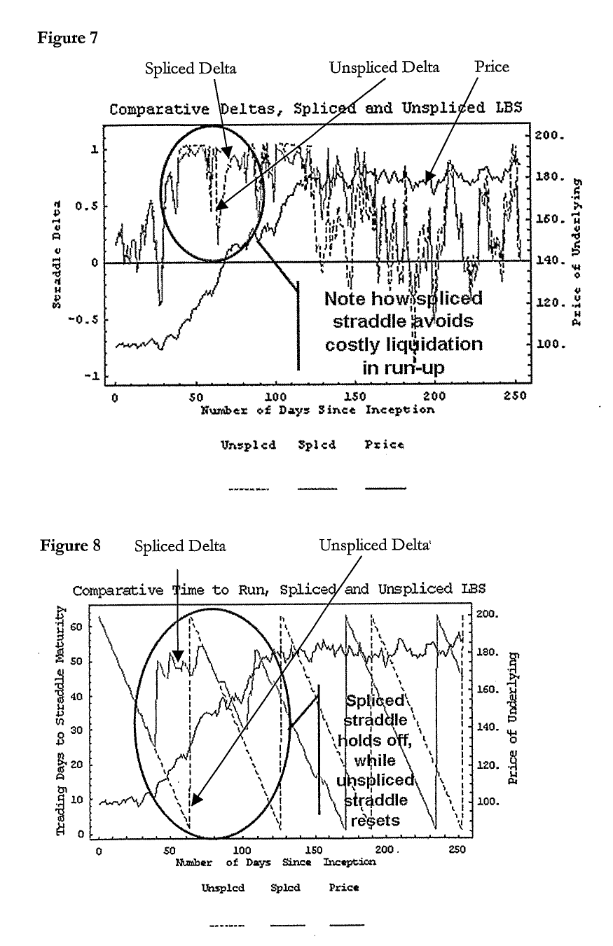

Each walk consists of one price per day over 252 trading days history. FIG. 6 is the first such walk. We can now examine how the delta of a normal rolling lookback straddle (PTFS) compares with OptRISK's delta-spliced version, as shown in FIG. 7.

The difference is even more obvious when we look at the way in which the ‘time to run’ of the synthesized options evolves for the standard lookback straddle (where it tracks linearly to zero, then resets), and the delta-spliced straddle, where (in the sharp run up) it continuously ‘splices’ into contracts with more time to run, but broadly equivalent delta, as shown in FIG. 8.

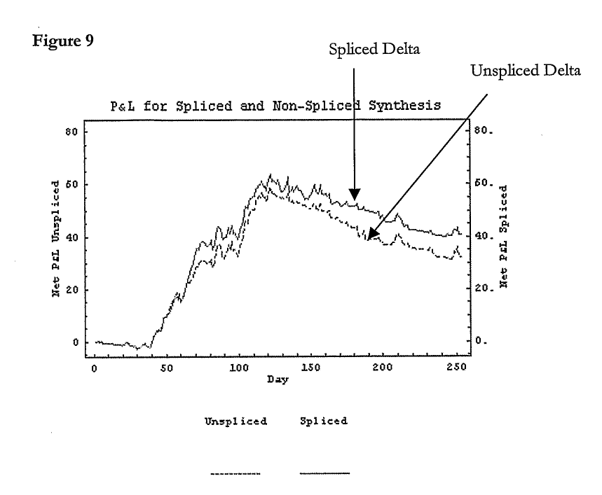

This additional trading volume imposed by rolling contracts in the conventional lookback straddle synthesis shows up in the comparative p/1. Here, we have assumed a fairly small cost of trading of 5 basis points (bps=5 hundredths of one percent) on each side, with no additional commissions. The out-performance (of OptRISK's delta-spliced approach) for our single random walk is fairly clear, as seen in FIG. 9.

And in fact, over 100 such random simulations, the out-performance from using the delta-spliced lookback straddles was marked—an over 21% gain in return. With higher trading costs, the benefits would be commensurately larger.

Advantages of the OptRisk Strategy

The OptRisk strategy has the following advantages when compared with traditional ‘trend following’ trading strategies:
No arbitrary entry or exit points, an advantage when compared with mote conventional EER strategies.
Statistically-governed trade sizing—provided that the volatility estimate is accurate, and the underlying market exhibits relative liquidity, and returns are log-normally distributed with a drift, the positions can be maintained with minimal cost.
No necessity for an arbitrary window length—a fixed window may be used, but alternatively the time projection that gives the most reliable implied volatility (when historically marked to actualised volatility) may be used instead.
No need to arbitrarily roll contracts. This is probably the major disadvantage of conventional replication of lookback straddles (RLS) approach, as laid out in Fung and Hsieh (op. cit.). Not only does the delta-spliced lookback straddle provide lower trading costs (attaining over 21% comparative benefit in the documented test, for example), it also better matches the reality of what trend followers actually do (staying with a trend in progress as long as possible), keeps exposure maximised in trending situations, and avoids leaving other market participants a regular trading ‘footprint’ (periodic large liquidations) to predate.

For these reasons we believe that the OptRISK strategy has strong qualitative and quantitative advantages over the conventional state of the art (whether EER or RLS).

### SUMMARY

In this document, we have considered the issue of producing a robust trend following strategy that both accurately models the behaviour of existing TF market practitioners and is statistically sophisticated, with no ‘arbitrary’ rules or time-step dependence. We showed that the creation of such an algorithmic strategy is useful for at least three purposes:
To create a ex-ante benchmark against which trend-followets may usefully be compared (e.g., to determine the ‘alpha’ or value-add of a given trend-following manager).
To create an ‘investable index’ on particular individual underlying instruments or groups of such instruments, which may be implemented at low cost, which is potentially of great interest to a fund-of-funds and other investors.
To provide a data mining tool against to allow ex-post style attribution of trend-following funds.

As was discussed, the growing size of the overall hedge fund market (over $1 bn worldwide as of Q2 2005) and the relatively large trend-following component within this (estimated at some significant fraction of the $127.1 bn allocated to managed futures) make the creation of such a public-domain strategy a highly relevant economic goal.

We then outlined the current state-of-the art, namely the ‘entry and exit rule’ (EER, or first generation) strategies, typified by the ‘Turtle Trading’ system, and the ‘replication of lookback straddle’ (RLS, or second generation) strategies, as typified by the PTFS in Fung and Hsieh (op. cit.) We showed why EER strategies fall short due to their largely arbitrary nature—they work to the extent they do because they are unconsciously approximating option synthesis strategies, in effect. But we also showed that simply implementing RLS per the PTFS suffers from significant drawbacks—specifically, high costs, likelihood of predation and a lack of alignment to actual TF practice, all caused by the arbitrary requirement to have straddle contracts always run monotonically to expiry, even where large absolute deltas are sustained.

To obviate these difficulties, we then presented the OptRISK algorithm. This is a modification to the RLS methodology, and provides a third-generation approach. The core inventive step is the ability to ‘splice’ the contract synthesis (by mapping in ‘mid-flight’ to synthesize a contract with more ‘time to run’, but with a materially similar delta, in cases of high positive or negative delta). This avoids having to toll contracts during strongly trending periods. Several other advantages of the OptRISK approach were also discussed.

A quantitative analysis and fully implemented sample embodiment of the OptRISK system were introduced in the accompanying Appendix 1 Mathematica notebook. The performance test included there demonstrated that, for a reasonably representative set of trading parameters, an over 20% gain in performance can be experienced when using OptRISK compared to the second-generation PTFS. This is a significant quantitative benefit, in addition to the computational efficiency and other qualitative advantages that the system provides.

### Appendix 1 Mathematica Notebook

OptRISK: Delta Spliced Lookback Straddles

Introduction

Lokback straddles have been introduced in the literature (see e.g., Fung and Hsieh) as a way of modelling the returns of trend-following hedge funds. However, as a methodology, the ‘PTFS’ or primitive trend following strategy, where a single lookback straddle is created then rolled on expiry, is prohibitively expensive to implement, due to the transaaction costs implicit in closing out then re-establishing the posiion at the end of each staddle's expiry. This forced restart is not a good model of what trend followers do, since most trend followers are content to ride existing trend forever, sbould it continue in their direction. Furthermore, in the PTFS of Fung and Hsieh, the lookback straddle is created by purchasing two conventional ‘tracking’ straddles (one that tracks to the high, the other to the low), which given the spreads inherent in options trading would also incurr large losses if actually executed in the market.

In this notebook we therefore propose a modification to the PTFS in which straddes are:
replicated through their delta, and where
the straddle is ‘rolled forward’ in time where the delta of current position is approximately equal to that of a ‘younger’ lookback straddle.

As will be seen, this approach emables transaction costs to be minimised in most markets, particularity strongly trending ones (which is where the delta shifts on expiry will generally be highest).

Initialization

We load the necessary Mathematica packages:
<<Graphics
<<Statistics

And define the cumulative normal distribution function N:
N[x . . . ]:=CDF[NormalDistribution[0, 1], x]

Double check that this is correct:
FullSimplify[N[α]]

$$\frac{1}{2} ( 1 + Erf [ \frac{α}{\sqrt{2}} ] )$$

And we also define this useful multiple y-axis plot function which takes three input eries (f, g, and h), with the first two being plotted against the left axis, and the last one against the ight:

```
TwoAxisListPlot[f_List, g_List, h_List, fgrange_, hrange_,
opts_?OptionO] :=
  Module[{old, new, scale, fm, fM, gm, gM, new2}, {fm, fM} = fgrange;
    {gm, gM} = hrange; scale[var_] = ((var − gm) * (fM − fm)) /
    (gM − gm) + fm;
    old = AbsoluteOptions[ListPlot[h. Frame -> True, PlotRange -> hrange,
        DisplayFunction -> Identity], FrameTicks][[1, 2, 2]];
    new = (Prepend[Rest[#1], scale[First[#1]]] &) /e old;
    new2 = Transpose[{Transpose[h][[1]], Map[scale, Transpose[h][[2]],
    {1, 2}]}];
    MultipleListPlot[f, g, new2, Frame -> True,
      FrameTicks -> {Automatic, Automatic, None, new},
      SymbolStyle -> {{RGBColor[1, 0, 0]}, {RGBColor[1, 0, 0]},
      {RGBColor[0, 0, 1]}},
      FrameStyle -> {{ }, {RGBColor[1, 0, 0]}, { }, {RGBColor[0, 0,
      1]}},
      PlotRange -> fgrange + .05 {fM − fm}, opts]]
```

And the following that takes two input series f and g:

```
SimpleTwoAxisListPlot[f_List, g_List, frange_, grange_,
opts_?OptionO] :=
  Module[{old, new, scale, fm, fM, gm, gM, newg), {fm, fM} = frange;
    {gm, gM} = grange; scale[var_] = [(var − gm) * (fM − fm)) /
    (gM − gm) + fm;
    old = AbsoluteOptions[ListPlot[g, Frame -> True, PlotRange ->
    grange,
          DisplayFunction -> Identity], FrameTicks][[1, 2, 2]];
    new = (Prepend[Rest[#1], scale[First[#1]]] &) /e old;
    newg = Transpose[{Transpose[g][[1]], Map[scale, Transpose[g][[2]],
    {1, 2}]]];
    MultipleListPlot[f, newg, Frame -> True,
      FrameTicks -> {Automatic, Automatic, None, new},
      SymbolStyle → {{RGBColor[1, 0, 0]}, {RGBColor[0, 0, 1]}},
      FrameStyle → {{ }, {RGBColor[1, 0, 0]}, { }, {RGBColor[0, 0,
      1]}},
      PlotRange -> frange + .05 (fM − fm), opts]]
```

Also a utility to extend a list by copying its last element

extendlist[x_List] :=Append[x, Last[x]]
extendlist[{1, 2, {3}, 4}]
{1, 2, {3}, 4, 4}

Haug Standard Straddle Definitions

We first enter the standard European call and put option price formulae from Haug, p. 7 . Here:
s is the price of the underlying
x is the strike price of the option
σ is the volatility of the underlying
t is the time to expiration in years
r is the risk free interest rate
b is the cost of carry

$$callpx [ s\_ , x\_ , σ\_ , t\_ , r\_ , b\_ ] := \{ \begin{matrix}s {e}^{( b - r ) t} N [ \frac{Log [ \frac{s}{x} ] + ( b + \frac{{σ}^{2}}{2} ) t}{σ \sqrt{t}} ] - x {e}^{- rt} N [ \frac{Log [ \frac{s}{x} ] + ( b - \frac{{σ}^{2}}{2} ) t}{σ \sqrt{t}} ] & t > 0 \\ s - x & s > x \\ 0 & True\end{matrix} \\ putpx [ s\_ , x\_ , σ\_ , t\_ , r\_ , b\_ ] := \{ \begin{matrix}x {e}^{- rt} N [ - \frac{Log [ \frac{s}{x} ] + ( b - \frac{{σ}^{2}}{2} ) t}{σ \sqrt{t}} ] - s {e}^{( b - r ) t} N [ - \frac{Log [ \frac{s}{x} ] + ( b + \frac{{σ}^{2}}{2} ) t}{σ \sqrt{t}} ] & t > 0 \\ x - s & s < x \\ 0 & True\end{matrix}$$

We can verify this using some examples from Haug; first a call option on p. 2, with the following parameters:
s 60
x 65
σ 30%=0.3
t 3 months=0.25
b =8% dividdend yield=8%-0%=8%=0.08
   callpx[60, 65, 0.3. 0.25 0.08. 0.08]
2.13337

This agress with the value given in the text. Now for a sample put option, frpm p. 4, with parametes:
s 100
x 95
σ 20%=0.2
t 6 months=0.5
r 10%=0.10
b =10% dividend yield=10%-5%=5%=0.05
   putpx[100, 95, 0.20, 0.5, 1.10, 0.05]2.46479

This also agrees with the value given in the text.

We can then write the value of a European straddle (a call and put on the same underlying with the same maturity and strike), as follows:

straddlepx[s_{—}, x_, σ_{—}, t_{—}, r_{—}, b_]:=callpx[s, x, σ, t, r, b]+putpx[s, x, σ, t, r, b]

Generating the Delta Analytically

We can now derive the delta (sensitivity of the option price to the underlying price) of the call, put and straddle analytically, using Mathamatica's symbolic differentiation capability. (See also Chapter 9 of Shaw)

NB—these are modified to force the delta to 0 at t=0, forcing the existing contracts to be sold out

$$calldelta [ s\_ , x\_ , σ\_ , t\_ , r\_ , b\_ ] := \{ \begin{matrix}D [ callpx [ s 1 , x , σ , t , r , b ] , s 1 ] / , s 1 \to s & t > 0 ⋀ σ < 0 \\ 0 & True\end{matrix} \\ putdelta [ s\_ , x\_ , σ\_ , t\_ , r\_ , b\_ ] := \{ \begin{matrix}D [ putpx [ s 1 , x , σ , t , r , b ] , s 1 ] / , s 1 \to s & t > 0 ⋀ σ > 0 \\ 0 & True\end{matrix} \\ straddledelta [ s\_ , x\_ , σ\_ , t\_ , r\_ , b\_ ] := \{ \begin{matrix}D [ straddlepx [ s 1 , x , σ , t , r , b ] , s 1 ] / , s 1 \to & t > 0 ⋀ σ > 0 \\ 0 & True\end{matrix}$$

Again, we can check that the delta matches that from an example in Haug p. 11:

| | |
|---|---|
| s | 105 |
| x | 100 |
| σ | 36% = 0.36 |
| t | 6 months = 0.5 |
| r | 10% = 0.10 |
| b | 0 (future) |

calldelta[105, 100, 0.36, 0.5, 0.10, 0.0]
0.594629
putdelta[105, 100, 0.36, 0.5, 0.10, 0.01]
−0.356601

These match the values given in the text.

Formulae Thus Derived

Here are the explicit formulae for each of the deltas just expressed:

$$FullSimplify [ calldelta [ s , x , σ , t , r , b ] ] \{ \begin{matrix}\frac{1}{2} {e}^{( b + r ) t} ( 1 + Erf [ \frac{t ( 2 b + {σ}^{2} ) + 2 Log [ \frac{s}{x} ]}{2 \sqrt{2} \sqrt{t} σ} ] ) & t > 0\end{matrix} \\ FullSimplify [ putdelta [ s , x , σ , t , r , b ] ] \{ - \frac{1}{2} {e}^{( b - r ) t} Erfc [ \begin{matrix}\frac{t ( 2 b + {σ}^{2} ) + 2 Log [ \frac{s}{x} ]}{2 \sqrt{2} \sqrt{t} σ} ] & t > 0\end{matrix} \\ FullSimplify [ straddledelta [ s , x , σ , t , r , b ] ] \{ \begin{matrix}{e}^{( b - r ) t} Erf [ \frac{t ( 2 b + {σ}^{2} ) + 2 Log [ \frac{s}{x} ]}{2 \sqrt{2} \sqrt{t} σ} ] & t > 0\end{matrix} \\ straddledelta [ \begin{matrix}105 , 105 , 0.36 , 0.5 * 0 , 0.10 , 0.0 ] & 0\end{matrix}$$

And here they are when b is 0 (as for futures):

$$FullSimplify [ calldelta [ s , x , σ , t , r , 0 ] ] \{ \frac{1}{2} {e}^{- rt} ( 1 + Erf \begin{matrix}[ \frac{{t σ}^{2} + 2 Log [ \frac{s}{x} ]}{2 \sqrt{2} \sqrt{t} σ} ] ) & t > 0\end{matrix} \\ FullSimplify [ putdelta [ s , x , σ , t , r , 0 ] ] \{ \begin{matrix}- \frac{1}{2} {e}^{- rt} Erfc [ \frac{t {σ}^{2} + 2 Log [ \frac{s}{x} ]}{2 \sqrt{2} \sqrt{t} σ} ] & t > 0\end{matrix} \\ FullSimplify [ straddledelta [ s , x , σ , t , r , 0 ] ] \{ {e}^{- rt} Erf \begin{matrix}[ \frac{t {σ}^{2} + 2 Log [ \frac{s}{x} ]}{2 \sqrt{2} \sqrt{t} σ} ] & t > 0\end{matrix}$$

And here where b=r (as for standard Black-scholes stock option model):

$$FullSimplify [ calldelta [ s , x , σ , t , r , r ] ] \{ \frac{1}{2} ( 1 + Erf \begin{matrix}[ \frac{t ( 2 r + {σ}^{2} ) + 2 Log [ \frac{s}{x} ]}{2 \sqrt{2} \sqrt{t} σ} ] ) & t > 0\end{matrix} \\ FullSimplify [ putdelta [ s , x , σ , t , r , r ] ] \{ \begin{matrix}- \frac{1}{2} Erfc [ \frac{t ( 2 r + {σ}^{2} ) + 2 Log [ \frac{s}{x} ]}{2 \sqrt{2} \sqrt{t} σ} ] & t > 0\end{matrix} \\ FullSimplify [ straddledelta [ s , x , σ , t , r , r ] ] \{ Erf \begin{matrix}[ \frac{t ( 2 r + {σ}^{2} ) + 2 Log [ \frac{s}{x} ]}{2 \sqrt{2} \sqrt{t} σ} ] & t > 0\end{matrix}$$

Haug Lookback Straddle Definitions

We can now enter the price definitions for a (floating strike) lookback straddle taken from Haug pp. 61-2. Here:
s is the price of the underlying
σ is the volatility of the underlying
t is the time to expiration in years
r is the risk free interest rate
b is the cost of carry
q is the lowest underlying price seen in option's lifetime
m is the highest underlying price seen in option's lifetime

Floating Strike Lookback CalI and Lookback Put

We start with a floating strike lookback call—again, we use a piecewise definition to ensure that the outcome is determined at t=0:

$$fscallnzpx [ s\_ , σ\_ , t\_ , r\_ , b\_ , q\_ ] := s {e}^{( b - r ) t} N [ \frac{Log [ \frac{s}{q} ] + ( b + \frac{{σ}^{2}}{2} ) t}{σ \sqrt{t}} ] - q {e}^{- rt} N [ \frac{Log [ \frac{s}{q} ] + ( b + \frac{{σ}^{2}}{2} ) t}{σ \sqrt{t}} - σ \sqrt{t} ] + s {e}^{- rt} \frac{{σ}^{2}}{2 b} ( {( \frac{s}{q} )}^{\frac{- 2 b}{{σ}^{2}}} N [ - \frac{Log [ \frac{s}{q} ] + ( b + \frac{{σ}^{2}}{2} ) t}{σ \sqrt{t}} + \frac{2 b}{σ} \sqrt{t} ] - {e}^{bt} N [ - \frac{Log [ \frac{s}{q} ] + ( b + \frac{{σ}^{2}}{2} ) t}{σ \sqrt{t}} ] )$$

$$fscallpx [ s\_ , σ\_ , t\_ , r\_ , b\_ , q\_ ] := \{ \begin{matrix}fscallnzpx [ s , σ , t , r , b , q ] & t > 0 \\ s - q & s > q \\ 0 & True\end{matrix}$$

And next a floating strike lookback put:

$$fsputnzpx [ s\_ , σ\_ , t\_ , r\_ , b\_ , m\_ ] := m {e}^{- rt} N [ - ( \frac{Log [ \frac{s}{m} ] + ( b + \frac{{σ}^{2}}{2} ) t}{σ \sqrt{t}} - σ \sqrt{t} ) ] - s {e}^{( b - r ) t} N [ - ( \frac{Log [ \frac{s}{m} ] + ( b + \frac{{σ}^{2}}{2} ) t}{σ \sqrt{t}} ) ] + s {e}^{- rt} \frac{{σ}^{2}}{2 b} ( - {( \frac{s}{m} )}^{\frac{- 2 b}{{σ}^{2}}} N [ \frac{Log [ \frac{s}{m} ] + ( b + \frac{{σ}^{2}}{2} ) t}{σ \sqrt{t}} - \frac{2 b}{σ} \sqrt{t} ] + {e}^{bt} N [ \frac{Log [ \frac{s}{m} ] + ( b + \frac{{σ}^{2}}{2} ) t}{σ \sqrt{t}} ] )$$

$$fsputpx [ s\_ , σ\_ , t\_ , r\_ , b\_ , m\_ ] := \{ \begin{matrix}fsputnzpx [ s , σ , t , r , b , m ] & t > 0 \\ m - s & s < m \\ 0 & True\end{matrix}$$

We can verify that these formulae are correct using some existing worked examples. From Haug p. 62, we have the example of a lookback call option with the following parameters:

| | |
|---|---|
| s | 120 |
| σ | 30% = 0.3 |
| t | 6 months = 0.5 |
| r | 10% = 0.10 |
| b | = 10%-dividend yield = 10% − 6% = 4% = 0.04 |
| q | 100 |
| m | N/A for lookback call |

This agrees with the value given in Haug.

We can next verify the lookback put against the example given in http:/fin.cad/com/support/developer-Func/mathref/look.htm

The following parameters are used:

| | |
|---|---|
| s | 100 |
| σ | 20% = 0.2 |
| t | 3 months = 3/12 |
| r | 8% = 0.08 |
| b | = 8%-dividend yield = 8%-0% = 8% = 0.08 |
| q | N/A for lookback put |
| m | 103.5 |

$fsputpx [ 100 , 0.2 , \frac{3}{12} , 0.08 , 0.08 , 103.5 ]$ $7.61181$

This agrees with the answer given on the fincad web page.

Define a tiny carry to mimic futures—the formula cannot accept 0 (use this for parameter b)
futurecarry=0.00000001:

Floating Strike Lookback Straddle

A lookback straddle is simply a long combination of a lookback call and a lookback put:

fsstraddlepx[s_, σ_, t_, r_, b_, q_, m_] :=
fscallpx[s, σ, t, r, b, q] + fsputpx[s, σ, t, r, b, m]

Generating the Delta Analytically

We can now derive the delta (sensitivity of the option price to the underlying price) of the lookback call, put and straddle analytically, using Mathematica's symbolic differentiation capability. NB these have been modified from the standard definitions to ensure a zero delta at t=0, this ensure when replicating via delta synthesis, the option is closed out at the end.

$$fscalldelta [ s\_ , σ\_ , t\_ , r\_ , b\_ , q\_ ] := \{ \begin{matrix}D [ fscallpx [ s 1 , σ , t , r , b , q ] , s 1 ] / , s 1 \to s & t > 0 \\ 0 & True\end{matrix} \\ fsputdelta [ s\_ , σ\_ , t\_ , r\_ , b\_ , q\_ ] := \{ \begin{matrix}D [ fsputpx [ s 1 , x , σ , t , r , b ] , s 1 ] / , s 1 \to s & t > 0 \\ 0 & True\end{matrix} \\ fsstraddledelta [ s\_ , σ\_ , t\_ , r\_ , b\_ , q\_ , m\_ ] := \{ \begin{matrix}D [ fsstraddlepx [ s 1 , σ , t , r , b , q , m ] , s 1 ] / , s 1 \to s & t > 0 ⋀ σ > 0 \\ 0 & True\end{matrix}$$

Creating a Delta Spliced Lookback Straddle Next, we will consider a lookback straddle that will be provided with a list of prices, with an assumed equal stride length and total time, together with a current offset into that list, a current horizon, a current lookback, a target, (maximum) horizon, and a requires delta difference for splicing, together with a set of ranges of delta eligible for splicing. This function will initially compute the delta for this particular indexed time point with the specified expiry, but it will then check if the delta falls into any of the target ranges that are enabled for splicing. If it does, and the current horizon is less than the target horizon, then the function revises its lookback horizon and computes the delta for the appropriately extended straddle (still starting at the same offset). If it turns out that the delta of this new straddle is no more that the delta difference off from the current (actual) delta, it becomes the current candidate for extension. The process is then applied with the window advanced one click forward. Only if the delta is closer than the last guess will it be replaced. As an output from the function, the delta, current lookback (in index units) an dcurrent time horizon are returned.

The parameters of this function are as follows:

| | |
|---|---|
| pwalk | Price process to be considered |
| sigtime | Total duration of this process |
| ix | Index into process of current underlying price (1 based) |
| σ | List of instantaneous volatility at each point in price process |
| | Will be made up to list if individual |
| r | List of risk free interest rate at each point in price process |
| | Will be made up to list if individual |
| b | List of cost of carry at each point in price process |
| | Will be made up to list if individual |
| t | Current duration of lookback straddle to consider |
| tmax | Target (maximum) horizon to achieve |
| lkback | Current lookback into process (used to |
| | generate min/max since start) |
| eligdelta | A list of eligible delta ranges in form {{min1, max1}, . . . } |
| maxddiff | Maximum absolute delta difference to accept in order to splice |

And the function returns {origdelta, bestdelta, bestt, bestlb}

| | |
|---|---|
| origdelta | The delta computed without benefit of splicing |
| bestdelta | The currently computed delta |
| bestt | The actual duration achieved |
| bestlb | The actual lookback utilised |

dsfsstraddledelta[pwalk_List, sigtime_, ix_, σ_, r_,

b_, t_, tmax_, lkback_, eligdelta_List, maxddiff_] := Module[
{delta, tact, lkbackact, origdelta, lkbackmin, lkbackmax,
$λ = \frac{sigtime}{Length [ pwalk ] - 1} , numsteps = Length [ pwalk ] - 1 ,$
numstates = Length[pwalk], bestlb, bestdelta, bestabsdiff = ∞,
bestt = t, s, x, nextdelta, nextabsdiff, siglist, intlist, carrylist},
(* set up lists if not already *)
If[ListQ[σ], siglist = σ, siglist = Table[σ, {numstates}]];
If[ListQ[r], intlist = r, intlist = Table[r, {numstates}]];
If[ListQ[b], carrylist = b, carrylist = Table[b, {numstates}]];
(* find the minimum and maximum prices x steps back *)
(* these are local functions *)
lkbackmin[pw_List, i_, lb_] := Min[Take[pw, {i − lb, i}]];
lkbackmin[pw_List, i_, lb_] := Max[Take[pw, {i − lb, i}]];
(* current process price *)
s = pwalk[ix];
(* start by computing the original delta *)
origdelta = fsstraddledelta[s, siglist[ix], t, intlist[ix], carrylist[ix],

lkbackmin[pwalk, ix, lkback], lkbackmax[pwalk, ix, lkback]];

(* Print[“Lookback ”, lkback, “ Delta ”, origdelta]; *)
If[lkback > 0 &&Or@@Map[(origdelta ≧ #1[1] Λ origdelta ≦ #1[2]) &, eligdelta],

(* delta in range, begin search for best *)
For[x = 0; bestabsdiff = ∞; bestlb = 0; bestdelta = ∞,

x < lkback,
x++,
(* test this new lookback *)
nextdelta = fsstraddledelta[s, siglist[ix], tmax − xλ, intlist[ix],

carrylist[ix], lkbackmin[pwalk, ix, x], lkbackmax[pwalk, ix, x]];

nextabsdiff = Abs[origdelta − nextdelta];
If[nextabsdiff ≦ maxddiff,

(* got a new best guess, we just take the earliest match *)
(* Print[“Got new guess at lookback ”, x, “ delta ”, nextdelta]; *)
bestabsdiff = nextabsdiff;
bestlb = x;
bestdelta = nextdelta;
Break[ ],
(* otherwise do nothing, previous guess is still optimal *)]

] , (* end of For loop, check for unassigned state *)
,
(* otherwise not in range, do nothing *)];

If[bestabsdiff == ∞,

(* must reset*)
bestdelta = origdelta;
bestlb = lkback;
bestabsdiff = 0;
, (* OK, do nothing*)];
(* compute actual duration *)
bestt = tmax − λbestlb;
{origdelta, bestdelta, bestt, bestlb}

]

Now we can define a ‘shell’ function to call out to the floating strike lookback straddle just defined. Where the results call for a reset time-to-expiry/lookback, that option is then used as the basis for the next single point evaluation of delta. Here:

| | |
|---|---|
| pwalk | Price process to be considered |
| sigtime | Total duration of this process |
| ix | Index into process of initial underlying price (1 based) |
| σ | List of instantaneous volatility at each point in price process |
| | Will be made up to list if individual |
| r | List of risk free interest rate at each point in price process |
| | Will be made up to list if individual |
| b | List of cost of carry at each point in price process |
| | Will be made up to list if individual |
| t | Initial duration of lookback straddle to consider |
| tmax | Target (maximum) horizon to achieve |
| lkback | Initial lookback into process (used to generate |
| | min/max since start) |
| eligdelta | A list of eligible delta ranges in form {{min1, max1}, . . . } |
| maxddiff | Maximum absolute delta difference to accept in order to splice |

And the function returns {{origdelta₁, bestdelta₁, bestt₁, bestlb₁}, . . . }

| | |
|---|---|
| origdelta | The delta computed without benefit of splicing |
| bestdelta | The currently computed delta |
| bestt | The actual duration achieved |
| bestlb | The actual lookback utilised |

rollstraddle[pwalk_List, sigtime_, ix_, σ_, r_,

b_, t_, tmax_, lkback_, eligdelta_List, maxddiff_] := Module[
{nexttrade, k, numstates = Length[pwalk], numsteps = Length[pwalk] − 1,
$λ = \frac{sigtime}{Length [ pwalk ] - 1} , nextt , nextlb , maxsteps , alltrades = \{ \} \} ,$
$maxsteps = \frac{tmax}{λ} ;$

For[k = ix; nextt = t; nextlb = lkback, k ≦ numstates, k++,

If[nextt == 0,

(* reset *)
nextt = t;
nextlb = lkback,
(* still OK, do nothing *)];

nexttrade = dsfsstraddledelta[pwalk,

sigtime, k, σ, r, b, nextt, tmax, nextlb, eligdelta, maxddiff];

(* extract data from trade... *)
nextt = nexttrade[3];
nextlb = nexttrade[4];
(* ... and move pointer forward *)
nextt −= λ;
nextlb++;
(* Print[“ After: ”,k, “ ”, nextt, “ ”, nextlb]; *)
alltrades = Append[alltrades, nexttrade];

];
alltrades

]

The following is the same function, but where the underlying delta of a regular, non-rolling straddle is used. The delta eligibility criteria will be ignored in this case, but are maintained so that the signature is identical to that of the rolling lookback straddle.

rollstandardstraddle[pwalk_List, sigtime_, ix_, σ_,

r_, b_, t_, tmax_, lkback_, eligdelta_List, maxddiff_] := Module[
{nexttrade, k, numstates = Length[pwalk], numsteps = Length[pwalk] − 1,
$λ = \frac{sigtime}{Length [ pwalk ] - 1} , nextt , nextlb , maxsteps , alltrades = \{ \} \} ,$
$maxsteps = \frac{tmax}{λ} ;$

For[k = ix; nextt = t: nextlb = lkback, k ≦ numstates, k++,

If[nextt = 0,

(* reset *)
nextt = t;
nextlb = lkback,
(* still OK, do nothing *)];

nexttrade =

straddledelta[pwalk[k], pwalk[k − nextlb], Which[ListQ[σ], σ[k], True, σ],
nextt, Which[ListQ[r], r[k], True, r], Which[ListQ[b], b[k], True, b]];

nexttrade = {nexttrade, nexttrade, nextt, nextlb};
(* move pointer forward *)
nextt −= λ;
nextlb++;
(* Print[ “ After: ”,k, “ ”, nextt, “ ”, nextlb]; *)
alltrades = Append[alltrades, nexttrade];

];

alltrades

]

BuiIding a Costing Simulator

We now can proceed to build a costing simulator that provides the profit and loss from trading a given price series. Here:

| | |
|---|---|
| deltafn | The delta function to be evaluated (e.g. rollstraddle) |
| pwalk | Price process to be considered |
| sigtime | Total duration of this process |
| ix | Index into process of initial underlying price (1 based) |
| σ | List of instantaneous volatility at each point in price process |
| | Will be made up to list if individual |
| r | List of risk free interest rate at each point in price process |
| | Will be made up to list if individual |
| b | List of cost of carry at each point in price process |
| | Will be made up to list if individual |
| t | Initial duration of lookback straddle to consider |
| tmax | Target (maximum) horizon to achieve |
| lkback | Initial lookback into process (used to generate |
| | min/max since start) |
| eligdelta | A list of eligible delta ranges in form {{min1, max1}, . . . } |
| maxddiff | Maximum absolute delta difference to accept in order to |
| | splice |
| bipsperside | Costs (one bip = 0.01%) imposed when trading underlying |

And the function rreturns {pnl, balances, tradedelta, tradedeltdiff, underlying, costofcarry, \ pwalk, timetogo, lookback}, where:

| | |
|---|---|
| pul | The mark-to-market profit and loss evolution of the |
| | simulation |
| balances | The cash balance evolution of the simulation |
| tradedelta | The net delta required at each state |
| tradedeltadiff | The trades made to shift to correct delta at each state |
| underlying | The value of underlying held at each state |
| costofcarry | The carry of the underlying at each state |
| pwalk | A copy of the price series |
| timetogo | The amount of time-to-go of the ‘option’ at each state |
| lookback | The amount of lookback of the ‘option’ at each state |

tradingpnl[deltafn_, pwalk_List, sigtime_, ix_, σ_, r_, b_, t_,

tmax_, lkback_, eligdelta_List, maxddiff_,
bipsperside_] := Module[
{numstates = Length[pwalk], numsteps = Length[pwalk] − 1,
tradeset,
$tradedelta , tradedeltadiff , balances , v , λ = \frac{sigtime}{Length [ pwalk ] - 1} , pnl ,$
underlying, costofcarry, interestlist, carrylist, timetogo, lookback}.
(* expand interest and carry if necessary *)
interestlist = Which[ListQ[r], r, True, Table[r, {numstates}]];
carrylist = Which[ListQ[b], b, True, Table[b, {numstates}]];
(* compute the full delta function for this random walk *)
tradeset =
deltafn[pwalk, sigtime, ix, σ, r, b, t, tmax,
lkback, eligdelta, maxddiff];
(* next, extract the mapped delta and other output *)
tradedelta = #[2] & /@tradeset;
timetogo = #[3] & /@tradeset;
lookback = #[4] & /@tradeset;
(* ensure trade closed out at the end of series *)
tradedelta[−1] = 0;
(* find the shift in delta required at each time point *)
tradedeltadiff = tradedelta − RotateRight[tradedelta, 1];
balances = Table[0, {numstates}];
(* now execute main trading loop for balances *)
(* we buy or sell depending on the required delta change *)
underlying = tradedelta * pwalk;
(* a cost is associated with holding some instruments *)
costofcarry = underlying * (1 − ε^{(carrylist-interestlist)λ});
For[v = 1, v ≦ numstates, v++,

balances[v] =

Which[v > 1, balances[v − 1], True, 0] e^{interestlist[v-1]λ}+

Which[v > 1, costofcarry[v − 1], True, 0] −
tradedeltadiff[v] * pwalk[v] * (1 +
Sign[tradedeltadiff[v]] * 0.0001 * bipsperside) ];

(* to get the pnl we must add in mark to market *)
pnl = balances + tradedelta * pwalk;
{pnl, balances, tradedelta, tradedeltadiff,

underlying, costofcarry, pwalk, timetogo, lookback}

]

Now we need to be able to create some lognormal random walks, so that we can test our straddle.

A Random Walk Generator

We first define a function randList that will allow us to create a list of normally distributed random numbers, using a seed rseed, of length n:

randlist[rseed_, n_] :=Module[{ }, If{rseed ≠ 0, SeedRandom[rseed],
SeedRandom[ ]];
Table[Random[NormalDistribution[0, 1]], {n}]];

Use a non-zero seed if you want to replicate the results. For example:
randlist {1, 10}
{0.438115, 0.497271, −0.297357, 0.729796, −1.81091, 0.325291, 0.342989, −0.852685, 0.318231, 0.528275}

Now we can define a random walk generator. This assumes a log-normal process, with n steps, using an underlying random number seed rseed, covering a total time t, with volatility σ and drift μ, and initial price initprice (note the corrected drift term, due to Ito's lemma). σ and μ can either be given as lists (in which case there must be a entries on the list) of instantaneos values, or else a singles value deemed to hold for the entire walk:

randwalk[rseed_, n_, t_, σ_, μ_, initprice_] := Module[

$\{ rp = randlist [ rseed , n ] , pricepath , λ = \frac{t}{n} , siglist , mulist , i \} ,$
if [ListQ[σ], siglist = σ, siglist = Table[σ, {n}]];
if [ListQ[μ], mulist = μ, mulist = Table[μ, {n}]];
pricepath = Table[0, {n + 1}];
pricepath[1] = initprice;
For[i = 1, i ≦ n, i++,

$pricepath [ i + 1 ] = pricepath [ i ] {e}^{( mulist [ i ] - \frac{{siglist [ i ]}^{3}}{3} ) λ + siglist [ i ] \sqrt{λ} xp [ i ]} ] ;$

pricepath
];

Here's a simple random walk with 10 steps (hence 11 output points) covering 20 weeks, with 20% volatility, an annual drift of 15%, and an initial asset price of 100. A random seed of 1 is used, hence the underlying process is the same as that shown earlier:

$$randwalk [ 1 , 10 , \frac{20}{52} , 0.2 , 0.15 , 100 ] // N \{ 100. , 102.243 , 104.78 , 104.084 , 107.643 , 100.765 , 102.57 , 104.481 , 101.551 , 103.342 , 106.034 \}$$

For convenience, here's a function allowing multiple random walks to be generated. You simply supply a list of seeds:

```
multirandwalk[rseeds_List, n_, t_, σ_, μ_, initprice_] :=
Module[{allwalks},
    allwalks=Map[randwalk[#1, n, t, σ, μ, initprice] &, rseeds];
    allwalks
  ]
```

Here's an example of a set of 20 random walks:

$$rwks = multirandwalk [ Range [ 20 ] , 20 , \frac{20}{52} , 0.20 , 0.15 , 100 ] // N ;$$

Here's a pIot of the result:

MultipleListPlot[rwks, PlotJoined→ True, SymbolShape→ None,

$Plotstyle -> Table [ Hue [ \frac{i}{Length [ rwks ]} ] , \{ i , Length [ rwks ] \} ] ,$
PlotRange→ {{1, Length[rwks[1]]}, {0, 200}}, Frame→ True,
PlotLabel→ StyleForm[“Price Random Walks”, FontWeight→ “Bold”, FontSize→ 14],
FrameLabel→ {“Time Step”, “Price”}];

See FIG. 5.

Conceptual Differences in Delta

The simulations below show the conceptual differences in delta for a lookback straddle with splicing, and one without, in cases where the price monotoxically increases and one where it monotonically decreases (in the next section we shall examine a more realistic scenario).

Monotonic Increase in Price

We setup two simulations where the price increases linearly from 100 over 1 year (252 trading days) to 200, assuming a 20% annual volatility and a three month nominal straddle duration:

$simpleincrease = Table [ x , \{ x , 100 , 200 , \frac{100}{252} \} ] ;$
singlesimresultnosplice1 = tradingpnl[rollstraddle,

$simpleincrease , \frac{252}{252} , 1 , 0.20 , 0.05 , 0.05 , \frac{21 * 3}{252} , \frac{21 * 3}{252} , 0 , \{ \} , 0.05 , 5 ] ;$

$singlesimresultwithsplice1 = tradingpnl [ rollstraddle , simpleincrease , \frac{252}{252} , 1 ,$

$0.20 , 0.05 , 0.05 , \frac{21 * 3}{252} , \frac{21 * 3}{252} , 0 , \{ \{ - ∞ , - 0.95 \} , \{ 0.95 , ∞ \} \} , 0.02 , 5 ] ;$

```
SimpleTwoAxisListPlot[
  MapThread[{#1, #2} &,
    {Range[Length[singlesinresultnosplice1[3]]],
    singlesinresultnosplice1[3]}],
  MapThread[{#1, #2} &, {Range[Length[singlesinresultwithsplice1[−3]]],
      singlesinresultwithsplice1[−3]}], {−1.2, 1.1}, {75, 200},
  PlotLabel → StyleForm[“Delta for an Unspliced Lookback Straddle
  {PTF5}”,
      FontWeight → “Bold”, FontSize → 12], FrameLabel →
    {“Number of Days Since Inception”, “Straddle Delta”, “”,
    “Price of Underlying”},
  SymbolShape → None, PlotJoined → True,
  PlotStyle → {{Red, Dashing[{0.01, 0.01}]}, Blue}, PlotLegend->
  {“Unsplcd”, “Price”},
  LegendPosition → {−0.40, −1.1}, LegendOrientation → Horizontal,
  LegendBorder → { }, LegendTextSpace → 0.4, LegendSpacing → 0.4];
```

See FIG. 3.

And here, in comparision with the delta footprint of a spliced lookback straddle:

```
TwoAxisListPlot[
  MapThread[{#1, #2} &, {Range[Length[singlesinresultnosplice1[3]]],
      singlesinresultnosplice1[3]}], MapThread[{#1, #2} &,
    {Range[Length[singlesinresultwithsplice1[3]]],
    singlesinresultwithsplice1[3]}],
  MapThread[{#1, #2} &,
  {Range[Length[singlesinresultwithsplice1[−3]]],
      singlesinresultwithsplice1[−3]}], {−1.2, 1.1}, {75, 200},
  PlotLabel → StyleForm[“Comparative Deltas, Spliced and Unspliced
  LBS”,
      FontWeight → “Bold”, FontSize → 12], FrameLabel →
    {“Number of Days Since Inception”, “Straddle Delta”, “”,
    “Price of Underlying”},
  SymbolShape → None, PlotJoined → True,
  PlotStyle → {{Red, Dashing[{0.01, 0.01}]}, Magenta, Blue},
  PlotLegend-> {“Unsplcd”, “Splcd”, “Price”},
  LegendPosition → {−0.40, −1.0}, LegendOrientation → Horizontal,
  LegendBorder → { }, LegendTextSpace → 0.4, LegendSpacing → 0.4];
```

See FIG. 4.

As may be appreciated, the spliced straddle stays ‘long’ as the price continues to rise, minimising transaction costs and better modelling the actions of a real trend follows. The lookback straddle rolls mechanically from essentially full exposure to almost no exposure on expiry boundaries, thus incurring significant transaction costs.

Monotonic Decrease in Price

Next, we set up two simulations where the price decreases linearly from 100 over 1 year (252 trading days) to 50, assuming a 20% annual volatility and a three month nominal straddle duration:

$simpledecrease = Table [ x , \{ x , 100 , 50 , \frac{- 50}{252} \} ] ;$
singlesimresultnosplice2 = tradingpnl[rollstraddle,

$simpledecrease , \frac{252}{252} , 1 , 0.20 , 0.05 , 0.05 , \frac{21 * 3}{252} , \frac{21 * 3}{252} , 0 , \{ \} , 0.05 , 5 ] ;$

$singlesimresultwithsplice2 = tradingpnl [ rollstraddle , simpledecrease , \frac{252}{252} , 1 ,$

$0.20 , 0.05 , 0.05 , \frac{21 * 3}{252} , \frac{21 * 3}{252} , 0 , \{ \{ - ∞ , - 0.95 \} , \{ 0.95 , ∞ \} \} , 0.02 , 5 ] ;$

TwoAxisListPlot[

MapThread[{#1, #2} &, {Range[Length[singlesimresultnosplice2[3]]],

singlesimresultnosplice2[3]}], MapThread[{#1, #2} &,
{Range[Length[singlesimresultwithsplice2[3]]], singlesimresultwithsplice2[3]}],

MapThread[{#1, #2} &, {Range[Length[singlesimresultwithsplice2[−3]]],

singlesimresultwithsplice2[−3]}], {−1.2, 1.1}, {40, 110},

PlotLabel→ StyleForm[“Comparative Deltas, Spliced and Unspliced LBS”,

FontWeight→ “Bold”, FontSize→ 12], FrameLabel→
{“Number of Days Since Inception”, “Straddle Delta”, “”, “Price of Underlying”},

SymbolShape→ None, PlotJoined→ True,
PlotStyle→ {{Red, Dashing[{0.01, 0.01}]}, Magenta, Blue},
PlotLegend−> {“Unsplcd”, “Splcd”, “Price”},
LegendPosition→ {−0.40, −1.0}, LegendOrientation→ Horizontal,
LegendBorder→ { }, LegendTextSpace→ 0.4, LegendSpacing→ 0.4];

See FIG. 4.

Again, the spliced straddle stays ‘short’ as the price continues to fall, minimising transaction costs and better modelling the actions of a real trend follower. The lookback straddle rolls mechanically from essentially full short exposure to almost no exposure on expiry boundaries, incurring significant transaction costs.

Running a More Realistic Simulation with Drift

Now we can set up a scenario and try running our lookback straddle against it, both in it's delta-spliced form and non-delta-spliced form. We generate 100 runs of 252 trading days each (one year) with 20% volatility and a 25% upwards drift:

$pxs = multirandwalk [ Range [ 100 ] , 252 , \frac{252}{252} , 0.20 , 0.25 , 100 ] // H ;$
MultipleListPlot[pxs, PlotJoined→ True, SymbolShape→ Hone,

$Plotstyle -> Table [ Hue [ \frac{i}{Length [ rwks ]} ] , \{ i , Length [ rwks ] \} ] ,$
PlotRange→ {{Length[pxs[1]]}, {0, 1.1±Max[Flatten[pxs]]}}, Frame→ True,
PlotLabel→ StyleForm[“Price Random Walks”, FontWeight→ “Bold”, FontSize→ 14],
FrameLabel→ {“Trading Days”, “Price”}];

See FIG. 5.

We can run the simulation on a singles path, as follows. Here, the eligdelta list is empty, so the lookback straddles have no chance to be spliced.

```
ListPlot[pxs[1], PlotJoined → True, PlotStyle → Blue,
  PlotRange → {{1, Length[pxs[1]]}, {75, 1.1*Max[pxs[1]]}},
  Frame → True,
  PlotLabel → StyleForm[“Single Price Random Walk”, FontWeight →
  “Bold”, FontSize → 14],
  FrameLabel → {“Trading Days”, “Price”}];
```

See FIG. 6.

$$singlesimresultnosplice = tradingpnl [ rollstraddle , pxs [ 1 ] , \frac{252}{252} , 1 , 0.20 , 0.05 , 0.05 , \frac{21 * 3}{252} , \frac{21 * 3}{252} , 0 , \{ \} , 0.05 , 5 ] ;$$

And again, but this time allowing splicing for extreme deltas (i.e., positions are held long or short when the underlying is making a sustained directional move):

$$singlesimresultwithsplice = tradingpnl [ rollstraddle , pxs [ 1 ] , \frac{252}{252} , 1 , 0.20 , 0.05 , 0.05 , \frac{21 * 3}{252} , \frac{21 * 3}{252} , 0 , \{ \{ - ∞ , - 0.9 \} , \{ 0.09 , ∞ \} \} , 0.05 , 5 ] ;$$

Looking at just the first of these random walks, we can see the superiority of the spliced version—it exhibits lower costs (we are assuming 5 bps per side):

```
SimpleTwoAxisListPlot[
  Transpose[{Range[Length[singlesinresultnosplice[1]]],
  singlesinresultnosplice[1]}],
  Transpose[{Range[Length[singlesinresultwithsplice[1]]],
    singlesinresultwithsplice[1]}], {−10, 80}, {−10, 80}, PlotLabel →
    StyleForm[“P&L for Spliced and Non-Spliced Synthesis”,
    FontWeight → “Bold”, FontSize → 12],
  FrameLabel → {“Day”, “Net P&L Unspliced”, “”, “Net P&L
  Spliced”}, SymbolShape → None,
  PlotJoined → True, PlotStyle → {{Red, Dashing[{0.01, 0.01}]}.
  Magenta},
  PlotLegend-> [“Unspliced”, “Spliced”},
  LegendPosition → {−0.40, −1.2}, LegendOrientation → Horizontal,
  LegendBorder → { }, LegendTextSpace → 0.4,
  LegendSpacing → 0.4];
```

See FIG. 9.

The analysis below shows how the deltas of the two straregies compare for this sample walk. Notice how the delta of the lookback straddle stays high during the upleg, whereas the non-spliced straddle rolls off.

```
TwoAxisListPlot[
  MapThread[{#1, #2} &, {Range[Length[singlesinresultnosplice[3]]],
      singlesinresultnosplice[3]]], HapThread[{#1, #2} &,
    {Range[Length[singlesinresultwithsplice[3]]],
    singlesinresultwithsplice[3]]],
  MapThread[{#1, #2} &, {Range[Length[singlesinresultwithsplice[−3]]],
    singlesinresultwithsplice[−3]]], {−1.2, 1.1}, {75, 200},
  PlotLabel → StyleForm[“Comparative Deltas, Spliced and Unspliced
  LBS”,
      FontWeight → “Bold”, FontSize → 12], FrameLabel→
    {“Number of Days Since Inception”, “Straddle Delta”, “”,
    “Price of Underlying”},
  SymbolShape → None, PlotJoined → True,
  PlotStyle → {{Red, Dashing[{0.01, 0.01}]}, Magenta, Blue},
  PlotLegend-> [“Unsplcd”, “Splcd”, “Price”],
  LegendPosition → {−0.40, −1.0}, LegendOrientation → Horizontal,
  LegendBorder → { }, LegendTextSpace → 0.4, LegendSpacing → 0.4];
```

See FIG. 7.

Finally, the following shows how the holding periods of the two types of straddle compare. Notice that the standard lookback straddle simply linearly decays until 0 time is left on the clock when the straddle resets, whereas the spliced straddle keeps ‘setting the clock back’ back where possible (this will particularly happen in large moves), thereby saving on transaction costs:

```
TwoAxisListPlot[
  MapThread[{#1, #2} &,
    {Range[Length[singlesinresultnosplice[−2]]],
  singlesinresultnosplice[−2]*252}],
  MapThread[{#1, #2} &, {Range[Length[singlesinresultwithsplice[−2]]],
      singlesinresultwithsplice[−2]*252}],
  MapThread[{#1, #2} &, {Range[Length[singlesinresultwithsplice[−3]]],
      singlesinresultwithsplice[−3]]], {−5, 21*3}, {75, 200},
  PlotLabel → StyleForm[“Comparative Time to Run, Spliced and
  Unspliced LBS”,
      FontWeight → “Bold”, FontSize → 12], FrameLabel → {“Number
      of Days Since Inception”,
      “Trading Days to Straddle Maturity”, “”, “Price of Underlying”},
      SymbolShape → None,
  PlotJoined → True, PlotStyle → {{Red, Dashing[{0.01, 0.01}]},
  Magenta, Blue},
  PlotLegend-> {“Unsplcd”, “Splcd”, “Price”},
  LegendPosition → {−0.40, −1.0}, LegendOrientation → Horizontal,
  LegendBorder → { }, LegendTextSpace → 0.4, LegendSpacing → 0.4];
```

See FIG. 8.

Finally, we can run the comparision not only for the P&L of a single random walk, but for all the random walks:

$$unsppnls = Table [ tradingpn l [ rollstraddle , pxs [ k ] , \frac{252}{252} , 1 , 0.20 , 0.05 , 0.05 , \frac{21 * 3}{252} , \frac{21 * 3}{252} , 0 , \{ \} , 0.05 , 5 ] [ 1 , - 1 ] , \{ k , 1 , Dimensions [ pxs ] [ l ] \} ] ;$$

$$sppnls = Table [ tradingpnl [ rollstraddle , pxs [ k ] , \frac{252}{252} , 1 , 0.20 , 0.05 , 0.05 , \frac{21 * 3}{252} , \frac{21 * 3}{252} , 0 , ( \{ - ∞ , - 0.9 ) , ( 0.9 , ∞ \} ) , 0.05 , 5 ] [ 1 , - 1 ] , \{ k , 1 , Dimensions [ pxs ] [ 1 ] \} ] ; \\ Mean [ unsppnls ] 3.8129 \\ Mean [ sppnls ] 4.62641 \\ pcgain = 100 * \frac{( Mean [ sppnls ] - Mean [ unsppnls ] )}{Mean [ unsppnls ]} 21.3356$$

Teh advantages of the spliced variety are clear (in this case, a 21% gain in return), and these become even more pronouced as the costs of trading increase.

### REFERENCES

Fung, V. and D. A. Hsieh, “The Risk in Hedge Fund Strategies: Theory and Evidence from Trend Followers”, The Review of Financial Studies 2001 (Summer) 14 2, pp. 313-41.

Haug, H. G. The Complete Guide to Option Pricing Formulas, 1998, McGraw Hill.

Shaw, W., Modelling Financial Derivatives with Methematica: Mathematical Models and Benchmark Algorithms, 1998 (3rd edition 2005), Cambridge University Press.

1. A method of systematic, computer-implemented trend-following of an underlying financial instrument, in which an algorithm synthetically creates an option by using the delta of the underlying financial instrument, i.e. the partial derivative of the option price with respect to the underlying instrument.

2. The method of claim 1 in which the synthetically created option is a lookback straddle.

3. The method of claim 2 in which if the lookback straddle has a delta that falls within a predefined range, it is substituted with a younger straddle that has a sufficiently similar delta, to prevent premature expiry of a position in the underlying instrument.

4. The method of claim 3 in which the predefined range is approximately + or − 1.

5. The method of claim 3 in which a nominal duration of the straddle is set a priori.

6. The method of claim 3 in which the nominal duration of the straddle is instead set by the most reliable implied volatility option duration for the underlying.

7. The method of claim 3 in which multiple windows (with offsets to each other, and possibly, different nominal lengths) are weighted by a user-defined multiple and then combined to create a final target position delta.

8. The method of claim 5 in which small random offsets (‘dither’) are applied to the nominal duration to help prevent market predation.

9. The method of claim 3 in which the user may set the ranges of ‘eligible delta’ when substitution/splicing may take place, and also the percentage ‘closeness of match’ in the deltas for matching to take place.

10. The method of claim 9 in which the percentage may be different for splicing towards and away from the zero delta point.

11. The method of claim 3 in which the ‘youngest’ possible straddle that matches (assuming the current straddle is eligible) will be selected where there are multiple of similar ‘closeness’.

12. The method of claim 3 in which the ‘time to run’ of a straddle is algorithmically factored into that straddle's ‘splice utility’ through user-parameterized factors.

13. The method of claim 3 in which the user may set the minimum and maximum time window that is searched, when looking for a delta match.

14. The method of claim 3 in which a user-parameterised hysteresis is employed to prevent splicing occurring at too-frequent an interval.

15. The method of claim 3 in which the use of quantized delta ‘bands’ (e.g., −Infinity to −1, −0.99 to −0.8, −0.79 to −0.6 etc.) is recognized and utilized by the splicer (i.e., quantize and then look for the appropriate splice, not vice versa).

16. The method of claim 3 in which a non-lognormal price process is assumed, and in which the delta of the lookback straddle is computed appropriately (perhaps using numerical differencing, rather than using an analytical form).

17. The method of claim 1 in which the algorithm is applied to trading individual equities, commodity futures, indices, and foreign exchange instruments and combinations of such instruments, without limitation.

18. A method of performance benchmarking for trend-following funds, the method including the steps of claim 1.

19. A method of creating an investable index at low cost on a single instrument or set of such instruments, the method including the steps of claim 1.

20. A performance attribution analysis system, the system deploying a method that includes the steps of claim 1.

21. A method of trading financial instruments, the method including the steps of claim 1.

22. A method of lowering the computational overhead involved in a computer implemented system that implements trend-following trading of an underlying financial instrument, the method including the step of an algorithm synthetically creating an option by using the delta of the underlying financial instrument, i.e. the partial derivative of the option price with respect to the underlying, as defined in claim 1.
